(19) United States
(12) Patent Application Publication
(10) Pub. No.: US 2022/0214767 A9
(43) Pub. Date: Jul. 7, 2022

(54) TOUCH SUBSTRATE AND METHOD FOR MANUFACTURING THE SAME

(71) Applicants: HEFEI XINSHENG OPTOELECTRONICS TECHNOLOGY CO., LTD., Hefei (CN); BOE TECHNOLOGY GROUP CO., LTD., Beijing (CN)

(72) Inventors: Kai QIAO, Beijing (CN); Guoshou ZOU, Beijing (CN); Peihuan NING, Beijing (CN); Shilin ZHU, Beijing (CN); Weiquan ZENG, Beijing (CN); Bin WAN, Beijing (CN); Tingting WANG, Beijing (CN)

(21) Appl. No.: 16/334,460

(22) PCT Filed: Sep. 3, 2018
(86) PCT No.: PCT/CN2018/103806

§ 371 Date: Mar. 19, 2019

(30) Foreign Application Priority Data
Sep. 12, 2017 (CN) 201710816317.6

(51) Int. Cl. G06F 3/044; G06F 3/041

(52) U.S. Cl. CPC G06F 3/0446; G06F 2203/04111; G06F 2203/04103; G06F 3/04164

(57) ABSTRACT

The present disclosure discloses a touch substrate and a method for manufacturing the same. The touch substrate includes a substrate, and a touch electrode and an electrostatic discharge structure connected to the touch electrode on the substrate. The electrostatic discharge structure is configured to discharge static electricity generated in the touch electrode.

### CROSS REFERENCE TO RELATED APPLICATIONS

This patent application is a National Stage Entry of PCT/CN2018/103806 filed on Sep. 3, 2018, which claims the benefit and priority of Chinese Patent Application No. 201710816317.6 filed on Sep. 12, 2017, the disclosures of which are incorporated by reference herein in their entirety as part of the present application.

### BACKGROUND

The present disclosure relate to the field of display technologies, and in particular, to a touch substrate and a method for manufacturing the same.

Capacitive touch technology has become the mainstream of touch technology due to its low cost and excellent user experience.

### BRIEF DESCRIPTION

Embodiments of the present disclosure provide a touch substrate and a method for manufacturing the same.

Embodiments of the present disclosure provide a touch substrate. The touch substrate includes a substrate, touch electrode, and an electrostatic discharge structure connected to the touch electrode on the substrate. The electrostatic discharge structure is configured to discharge static electricity generated in the touch electrode.

In an embodiment of the present disclosure, the touch electrode has an opening. An orthographic projection of the electrostatic discharge structure on the substrate is located within the opening.

In an embodiment of the present disclosure, the electrostatic discharge structure includes a conductive grid structure.

In an embodiment of the present disclosure, the conductive grid structure includes a first wiring and a second wiring intersecting with each other.

In an embodiment of the present disclosure, an end of the first wiring and an end of the corresponding second wiring are joined at an edge region of the electrostatic discharge structure to form a discharge tip.

In an embodiment of the present disclosure, a width of a portion, intersecting with the second wiring, of the first wiring is smaller than a width of a portion, not intersecting with the second wiring, of the first wiring. A width of a portion, intersecting with the first wiring, of the second wiring is smaller than a width of a portion, not intersecting with the first wiring, of the second wiring.

In an embodiment of the present disclosure, the touch electrode includes a first touch electrode disposed along a first direction and a second touch structure disposed along a second direction constituting a mutual-capacitive touch structure. The first touch electrode includes a first electrode and a first conductive structure connecting the adjacent first electrodes. The second touch electrode includes a second electrode and a second conductive structure connecting the adjacent second electrodes. The first conductive structure and the second conductive structure intersect with each other and are insulated from each other. At least one of the first electrode and the second electrode has the opening. The electrostatic discharge structure is connected to a corresponding electrode of the first electrode and the second electrode, the corresponding electrode having the opening covered by the orthographic projection of the electrostatic discharge structure.

In an embodiment of the present disclosure, the electrostatic discharge structure is disposed in the same layer as the second conductive structure.

In an embodiment of the present disclosure, the touch electrode includes a third touch electrode constituting a self-capacitive touch structure. The third touch electrode has the opening. The electrostatic discharge structure is connected to the third touch electrode.

In an embodiment of the present disclosure, the touch electrode further includes a first insulating layer located on the third touch electrode, and a third wiring located on the first insulating layer, the third wiring being connected to the third touch electrode through a first hole in the first insulating layer.

In an embodiment of the present disclosure, a material of the first wiring and the second wiring includes a metal material.

Embodiments of the present disclosure also provide a method for manufacturing a touch substrate. The method includes providing a substrate and forming a touch electrode and an electrostatic discharge structure connected to the touch electrode on the substrate. The electrostatic discharge structure is configured to discharge static electricity generated in the touch electrode.

In an embodiment of the present disclosure, the touch electrode has an opening. An orthographic projection of the electrostatic discharge structure on the substrate is located within the opening.

In an embodiment of the present disclosure, the electrostatic discharge structure includes a conductive grid structure.

In an embodiment of the present disclosure, the conductive grid structure includes a first wiring and a second wiring intersecting with each other.

In an embodiment of the present disclosure, an end of the first wiring and an end of the corresponding second wiring are joined at an edge region of the electrostatic discharge structure to form a discharge tip.

In an embodiment of the present disclosure, a width of a portion, intersecting with the second wiring, of the first wiring is smaller than a width of a portion, not intersecting with the second wiring, of the first wiring. A width of a portion, intersecting with the first wiring, of the second is smaller than a width of a portion, not intersecting with the first wiring, of the second wiring.

In an embodiment of the present disclosure, forming the touch electrode and the electrostatic discharge structure includes forming a first conductive layer on the substrate, patterning the first conductive layer to form a first electrode and a first conductive structure disposed along a first direction, a second electrode disposed along a second direction, and the opening in at least one of the first electrode and the second electrode, the first conductive structure connecting the adjacent first electrodes, forming a first insulating layer on the first conductive structure, forming a second conductive layer to cover the first electrode, the second electrode, the opening, and the first insulating layer, and patterning the second conductive layer to form a second conductive structure and the electrostatic discharge structure disposed along the second direction, the second conductive structure intersecting with the first conductive structure and connecting the adjacent second electrodes, the electrostatic discharge structure being connected to a corresponding electrode of the first electrode and the second electrode, the corresponding electrode having the opening covered by the orthographic projection of the electrostatic discharge structure. The first electrode and the first conductive structure constitute a first touch electrode, the second electrode and the second conductive structure constitute a second touch electrode, and the first touch electrode and the second touch electrode constitute a mutual-capacitive touch structure.

In an embodiment of the present disclosure, forming the touch electrode and the electrostatic discharge structure includes forming a third conductive layer on the substrate, patterning the third conductive layer to form a third touch electrode and the opening in the third touch electrode, the third touch electrode constituting a self-capacitive touch structure, forming a first insulating layer on the third touch electrode, the first insulating layer having a first hole exposing the third touch electrode, forming a fourth conductive layer to cover the first insulating layer; and patterning the fourth conductive layer to form the electrostatic discharge structure and a third wiring connected to the third touch electrode through the first hole, the electrostatic discharge structure being connected to the third touch electrode.

In an embodiment of the present disclosure, the first insulating layer further includes a second hole exposing the opening, wherein the electrostatic discharge structure is located within the opening.

Further aspects and regions of applicability will become apparent from the description provided herein. It should be understood that various aspects of this disclosure may be implemented individually or in combination with one or more other aspects. It should also be understood that the description and specific examples herein are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a top view of a touch substrate according to an embodiment of the present disclosure;

FIG. 2 is a schematic cross-sectional view taken along line A-A of FIG. 1;

FIG. 3 is a top view of a first wiring, a second wiring, and an electrostatic discharge structure according to an embodiment of the present disclosure;

FIG. 4 is a top view of a touch substrate according to an embodiment of the present disclosure;

FIG. 5 is a cross-sectional view taken along line B-B of FIG. 4;

FIG. 6 is a flowchart of a method for manufacturing a touch substrate according to an embodiment of the present disclosure; and

FIG. 7 is a flowchart of a method for manufacturing a touch substrate according to an embodiment of the present disclosure.

Corresponding reference numerals indicate corresponding parts or features throughout the several views of the drawings.

### DETAILED DESCRIPTION

In order to enable those skilled in the art to better understand the technical solutions of the present disclosure, a touch substrate and a method for manufacturing the same according to embodiments of the present disclosure are described in detail below with reference to the accompanying drawings. The following description of the embodiments is for the purposes of illustration and description, which is not intended to be exhaustive or to limit the precise form disclosed.

In a capacitive touch substrate, static charges are easily present on the touch electrodes. With the accumulation of static charges, electrostatic discharge is extremely prone to occur at some weak positions on the touch electrode, for example, a position where a bridge line in a mutual-capacitive touch electrode is located, and a position where a connection between a self-capacitive touch electrode and its corresponding signal wiring is located, and a large current is generated. Thus, the weak positions are subjected to defects such as breakdown, fusing, etc., thereby, causing damage to the touch electrode and affecting the function of the product.

Embodiments of the present disclosure provide a touch substrate. The touch substrate includes a substrate, and a touch electrode on the substrate and an electrostatic discharge structure connected to the touch electrode. The electrostatic discharge structure is configured to discharge static electricity generated in the touch electrode.

In the embodiment of the present disclosure, when static charges are generated in the touch structure, static charges will accumulate at the electrostatic discharge structure without accumulating at the touch electrode by connecting the touch electrode to the electrostatic discharge structure. When energy of the static charges is too high, the static charges are discharged at the electrostatic discharge structure, thereby avoiding defects of the touch electrode, such as the breakdown, the fusing, etc., caused by the discharging of the static charges at the touch electrode. Thus, the electrostatic discharge structure can induce the accumulating and the discharging of the static charges in the touch structure at the electrostatic discharge structure, thereby protecting the touch electrode.

In an embodiment of the present disclosure, the touch electrode has an opening. An orthographic projection of the electrostatic discharge structure on the substrate is located within the opening.

It should be noted that the touch electrode in the embodiments of the present disclosure may be either mutual-capacitive touch electrode or self-capacitive touch electrode.

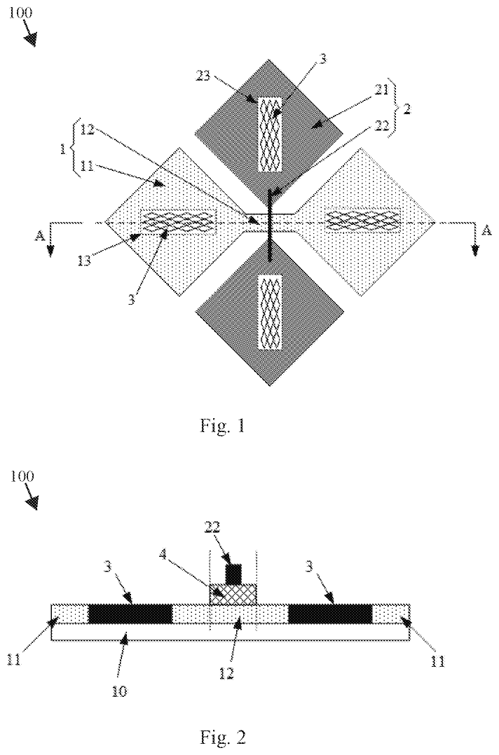

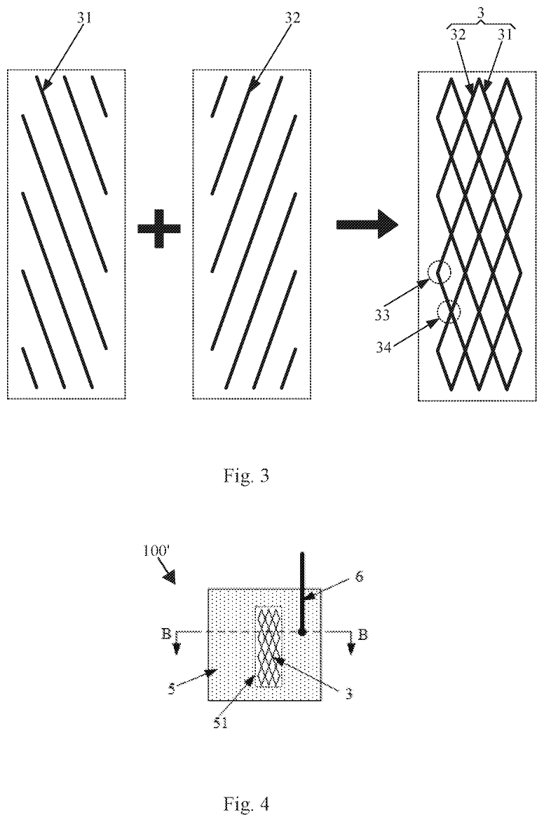

FIG. 1 is a top view of a touch substrate according to an embodiment of the present disclosure. FIG. 2 is a schematic cross-sectional view taken along line A-A of FIG. 1. As shown in FIG. 1 and FIG. 2, a touch substrate 100 includes a substrate 10, and a touch electrode and an electrostatic discharge structure 3 on the substrate 10. The touch electrode in the embodiments of the present disclosure is the mutual-capacitive touch electrode. Specifically, the touch electrode includes a first touch electrode 1 disposed along a first direction and a second touch electrode 2 disposed along a second direction. The first touch electrode 1 includes a first electrode 11 and a first conductive structure 12 connecting the adjacent first electrodes 11. The second touch electrode 2 includes a second electrode 21 and a second conductive structure 22 connecting the adjacent second electrodes 21. In an embodiment of the present disclosure, the first conductive structure 12 and the second conductive structure 22 intersect with each other and are insulated from each other.

As shown in FIGS. 1 and 2, in an embodiment of the present disclosure, at least one of the first electrode 11 and the second electrode 21 has an opening 13. The electrostatic discharge structure 3 is connected to a corresponding electrode of the first electrode 11 and the second electrode 21. The corresponding electrode has an opening 13 or 23 covered by the orthographic projection of the electrostatic discharge structure 3.

Specifically, the first electrode 11 has an opening 13 therein, and the electrostatic discharge structure 3 is located within the opening 13 and connected to the corresponding first electrode 11. The second electrode 21 has an opening 23 therein, and the electrostatic discharge structure 3 is located within the opening 23 and connected to the corresponding second electrode 21. In an embodiment of the present disclosure, the structures of the first electrode 11 and the second electrode 21 are designed, such that at least one of the first electrode 11 and the second electrode 21 has an opening, and the orthographic projection of the electrostatic discharge structure 3 on the substrate 10 is located within the opening 13 or 23, thereby the electrostatic discharge structure 3 does not affect the normal touch function of the touch electrode when performing electrostatic discharging.

In addition, even if the breakdown or the fusing, etc. of the electrostatic discharge structure 3 is occurred due to discharging, the corresponding touch electrode can still operate normally.

In the embodiment of the present disclosure, as shown in FIG. 2, the first electrode 11 of the first touch electrode 1 has an opening 13 therein, and the second electrode 21 of the second touch electrode 2 has an opening 23 therein. Electrostatic discharge structures 3 are disposed within the openings of the first electrode 11 and the second electrode 21. That is, the two electrodes connected to each conductive structure are connected with the electrostatic discharge structure 3, which can effectively improve the antistatic capability at each conductive structure.

It should be noted that, the case of the electrostatic discharge structure 3 is on the same layer as the first electrode 11 and the second electrode 21 as described above is an example embodiment of the present disclosure, which facilitates the electrostatic discharge structure 3 to be directly connected to the first electrode 11 and the second electrode 21. In an embodiment of the present disclosure, a first insulating layer 4 may also be located within the opening. The electrostatic discharge structure 3 is located on the first insulating layer 4. The orthographic projection of the electrostatic discharge structure 3 on the substrate 10 is located within the corresponding opening 13 or 23 (the corresponding figure of this case is not given). It should be noted that, in the embodiment of the present disclosure, it is only necessary to ensure that the orthographic projection of the electrostatic discharge structure 3 on the substrate 10 is located within the corresponding opening 13 or 23, so that the discharging behavior of the electrostatic discharge structure 3 will not affect the first touch electrode 1 and the second touch electrode 2.

It should be noted that, the case of the first touch electrode 1 shown in the drawing including two first electrodes 11 and the second touch electrode 2 including two second electrodes 21 is only illustrative and will be a limit to the present disclosure. It should be understood by those skilled in the art that the number of the first electrode 11 and the second electrode 21 in the embodiment of the present disclosure may also be three or more.

In the embodiment of the present disclosure, the first electrode 11, the first conductive structure 12, and the second electrode 21 are disposed in the same layer on the substrate 10. The first insulating layer 4 is disposed above the first conductive structure 12, and the second conductive structure 22 is located on the first insulating layer 4. That is, the second conductive structure 22 serves as a conductive bridge line.

In an exemplary embodiment of the present disclosure, the material of the first electrode 11, the first conductive structure 12, and the second electrode 21 includes indium tin oxide.

In an embodiment of the present disclosure, the electrostatic discharge structure 3 is disposed in the same layer as the second conductive structure 22. As an example, the material of the electrostatic discharge structure 3 and the second conductive structure 22 includes a metal material.

In an embodiment of the present disclosure, both the first conductive structure 12 and the second conductive structure 22 are electrically connected to the corresponding electrostatic discharge structure 3.

Generally, since the electrostatic discharge structure 3 is not present on the mutual-capacitive touch electrode, and the impedance at the position of the first conductive structure 12 for connecting the first electrode 11 (the line width is narrow) and at the position of the second conductive structure 22 for connecting the second electrode 21 (the line width is narrow) is relatively large, the static charges tend to accumulate at positions, having relatively large impedance, of the first conductive structure 12 and the second conductive structure 22 when the static charges are generated on the mutual-capacitive touch electrode. With the accumulation of the static charges, when the energy of the static charges is too high, electrostatic discharge will occur at the first conductive structure 12 and the second conductive structure 22, causing the breakdown and the fusing of the first conductive structure 12 and the second conductive structure 22, and then causing damage to the mutual-capacitive touch electrode.

Thus, in the embodiment of the present disclosure, by electrically connecting the first conductive structure 12 and the second conductive structure 22 to the electrostatic discharge structure 3, the accumulating and the discharging of the static charges on the first conductive structure 12 and the second conductive structure 22 can be effectively prevented, thereby protecting the first touch electrode 1 and the second touch electrode 2.

Specifically, taking the first touch electrode 1 as an example, when static charges are generated in the first touch electrode 1, the static charges may be accumulated on the electrostatic discharge structure 3 electrically connected to the first conductive structure 12 and no longer accumulated on the first conductive structure 12. When the energy of the static charge is too high, the static charges are discharged at the electrostatic discharge structure 3, so that the fusing of the first conductive electrode 12 due to the electrostatic discharge may be prevented and the damage to the first touch electrode 1 may be prevented. Thus, the electrostatic discharge structure 3 can induce the accumulating and the discharging of the static charges in the first touch electrode 1 electrically connected to the electrostatic discharge structure 3, thereby protecting the first touch electrode 1 (the first conductive structure 12).

For the principle that protecting the second touch electrode 2 by providing the electrostatic discharge structure 3 electrically connected to the second conductive structure 22 in the second touch electrode 2, reference may be made to the foregoing description, and details are not described herein again.

It should be noted that, the case of the first conductive structure 12 and the second conductive structure 22 being both electrically connected to the corresponding electrostatic discharge structure 3 is an example embodiment of the present disclosure, which can implement a protection to the first touch electrode 1 and the second touch electrode 2 in the touch structure. It should be understood to those skilled in the art that, only the first conductive structure 12 or only the second conductive structure 22 being connected to the electrostatic discharge structure 3 so as to protect the first touch electrode 1 or the second touch electrode 2 in the touch structure is also within the scope of protection of the present disclosure.

FIG. 3 is a top view of a first wiring, a second wiring, and an electrostatic discharge structure according to an embodiment of the present disclosure. As shown in FIG. 3, the electrostatic discharge structure 3 includes a conductive grid structure 3. The conductive grid structure 3 includes a first wiring 31 and a second wiring 32 intersecting with each other.

In an exemplary embodiment of the present disclosure, material of the first wiring 31 and the second wiring 32 include a metal material.

In the embodiment of the present disclosure, the electrostatic discharge structure 3 is designed as a grid shape composed of wirings, which on the one hand may enhance the capability of accumulating the static charges of the electrostatic discharge structure 3 due to a narrow wiring width and a large impedance, and on the other hand, such that when the touch substrate is applied to the display panel, the electrostatic discharge structure 3 in the grid shape has less influence on the light exiting of the pixels in the display panel and may block a plurality of pixels uniformly, avoid color shift, and increase the light transmittance.

It should be noted that, the case of the electrostatic discharge structure 3 being in a grid shape as described above is only an example embodiment of the present disclosure, which does not limit the technical solution of the present disclosure. The electrostatic discharge structure 3 in the present disclosure may also be in other shape (for example, plate shape or strip shape), which will not be exemplified here.

Further, an end of the first wiring 31 and an end of the second wiring 32 are joined at the edge region of the electrostatic discharge structure 3 to form the discharge tip 33, or the end of the second wiring 32 and the end of the first wiring 31 are joined at the edge region of the electrostatic discharge structure 3 to form a discharge tip 33.

In the electrostatic discharge structure 3 in the grid shape provided by the embodiment of the present disclosure, the first wiring 31 and the second wiring 32 are joined at the edge region of the electrostatic discharge structure 3 to form a first discharge tip 33. Due to the radius of the curvature of the discharge tip 33 is extremely small, it is advantageous for electrostatic discharge.

Further, the width of a portion, intersecting with the second wiring 32, of the first wiring 31 is smaller than the width of a portion, not intersecting with the second wiring 32, of the first wiring 31, the width of a portion, intersecting with the first wiring 31, of the second wiring 32 is smaller than the width of a portion, not intersecting with the first wiring 31, of the second wiring 32.

In the electrostatic discharge structure 3 in the grid shape provided by the embodiment of the present disclosure, the width of a portion, intersecting with other wirings, of a wiring is smaller than the width of a portion, not intersecting with other wirings, of the wiring. That is, the resistance of the portion, intersecting with other wirings, of the wiring is relatively large. At this time, for the electrostatic discharge structure 3 in the grid shape, the resistance of the portion, intersecting with other wirings, of the wiring is relatively large, which is advantageous for electrostatic discharge.

It can be seen from the above that, the positions, used for the electrostatic discharge, of the electrostatic discharge structure 3 provided by the embodiment of the present disclosure is mainly at the discharge tip 33 in the edge region and at the portion the wirings intersecting with each other 34 in the intermediate region. Thus, even the breakdown, the fusing, etc. of one or more discharge tips 33 and the portion the wirings intersecting with each other 34 in the electrostatic discharge structure 3 occur due to the electrostatic discharge, other normal discharge tips 33 and other portion the wirings intersecting with each other 34 in the electrostatic discharge structure 3 can still maintain the functions of the accumulating and the discharging of the static electricity in the electrostatic discharge structure 3.

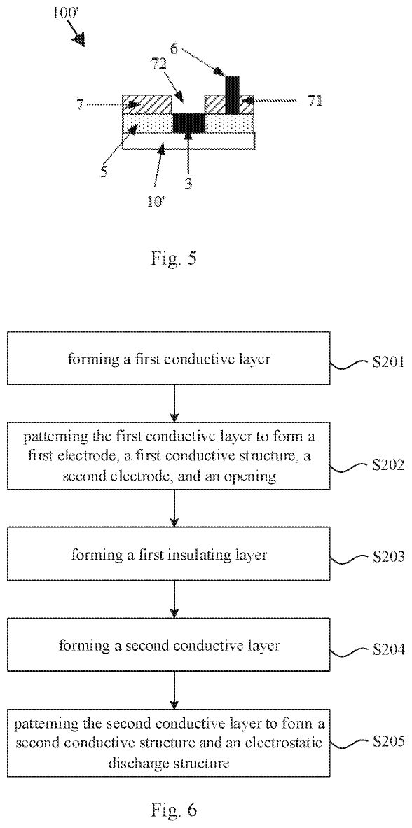

FIG. 4 is a top view of a touch substrate according to an embodiment of the present disclosure. FIG. 5 is a schematic cross-sectional view taken along line B-B of FIG. 4. As shown in FIGS. 4 and 5, the touch substrate 100′ includes a substrate 10′, and a touch electrode and an electrostatic discharge structure 3 on the substrate 10′. Different from the above embodiments, the touch electrode is a self-capacitive touch electrode. Specifically, the touch electrode includes a third touch electrode 5. The third touch electrode 5 has an opening 51. An orthographic projection of the electrostatic discharge structure 3 on the substrate 10′ is located within the opening 51. The electrostatic discharge structure is connected to the third touch electrode 5.

Generally, since the electrostatic discharge structure 3 is not present on the self-capacitive touch electrode, and the impedance at the connection between the signal wiring 6 (hereinafter referred to as “a third wiring 6”) and the third touch electrode 5 (also referred to as “self-capacitive touch electrode 5”) is relatively large, when static charges are generated on the self-capacitive touch electrode, the static charges tends to accumulate at the connection. With the accumulation of the static charges, when the energy of the static charges is too high, electrostatic discharge occurs at the connection, thereby causing an open circuit between the third wiring 6 and the self-capacitive touch electrode 5, and then resulting in the failure of the touch recognition function.

Therefore, in the embodiment of the present disclosure, by connecting the third touch electrode 5 and the electrostatic discharge structure 3, the accumulating and the discharging of the static charges at the connection between the third touch electrode 5 and the third wiring 6 can be effectively prevented, thereby protecting the third touch electrode 5.

In the embodiment of the present disclosure, the opening 51 is disposed in the third touch electrode 5, and the orthographic projection of the electrostatic discharge structure 3 on the substrate 10′ is located within the opening 51, so that the electrostatic discharge structure 3 does not affect the normal touch function of the third touch electrode 5 when performing the electrostatic discharge.

In an embodiment of the present disclosure, the touch electrode further includes a first insulating layer 7 located on the third touch electrode 5. The third wiring 6 is located on the first insulating layer 7 and is connected to the third touch electrode 5 through a first hole 71 located in the first insulating layer 7.

It should be noted that, the first insulating layer 7 shown in the drawing does not cover the opening 51, and the case of the electrostatic discharge structure 3 and the third touch electrode 5 being disposed on the same layer is an example embodiment of the present disclosure, which facilitates the electrostatic discharge structure 3 to be directly connected to the third touch electrode 5. In an embodiment of the present disclosure, the first insulating layer 7 may also cover the opening 51, and the electrostatic discharge structure 3 is located on the first insulating layer 7 and the orthographic projection of the electrostatic discharge structure 3 on the substrate 10′ is located within the opening 51 (the corresponding drawing of this case is not given). In the embodiment of the present disclosure, it is only necessary to ensure that the orthographic projection of the electrostatic discharge structure 3 on the substrate 10′ is located within the opening 51, so that the discharging behavior of the electrostatic discharge structure 3 does not affect the self-capacitive touch electrode.

In the embodiment of the present disclosure, the electrostatic discharge structure 3 is disposed in the same layer as the second wiring 6.

Embodiments of the present disclosure also provide a method for manufacturing a touch substrate. The method includes in step S101, providing a substrate, and in step S102, forming a touch electrode and an electrostatic discharge structure connected to the touch electrode on the substrate, the electrostatic discharge structure being configured to discharge static electricity generated in the touch electrode.

In an embodiment of the present disclosure, the touch electrode has an opening. An orthographic projection of the electrostatic discharge structure on the substrate is located within the opening.

FIG. 6 is a flowchart of a method for manufacturing a touch substrate according to an embodiment of the present disclosure. The touch substrate manufactured by the method is as shown in FIGS. 1 and 2. In the method, forming the touch electrode and the electrostatic discharge structure includes the following steps.

In step S201, a first conductive layer is formed on the substrate 10.

In step S202, the first conductive layer is patterned to form a first electrode 11 and a first conductive structure 12 disposed along a first direction, a second electrode 21 disposed along a second direction, and an opening 13 or 23 located in at least one of the first electrode 11 and the second electrode 21, the first conductive structure 12 being connected to the first electrode 11 adjacent to it.

In step S203, a first insulating layer 4 is formed on the first conductive structure 12.

In step S204, a second conductive layer is formed to cover the first electrode 11, the second electrode 21, the opening 13, and the first insulating layer 4.

In step S205, the second conductive layer is patterned to form a second conductive structure 22 and an electrostatic discharge structure 3 disposed along the second direction. The second conductive structure 22 intersects with the first conductive structure 12 and is connected to the second electrode 21 adjacent to it. The electrostatic discharge structure 3 is connected to the corresponding electrode of the first electrode 11 and the second electrode 21. The corresponding electrode has the opening 13 or 23 covered by the orthographic projection of the electrostatic discharge structure 3.

In the embodiment of the present disclosure, the first electrode 11 and the first conductive structure 12 constitute a first touch electrode 1, and the second electrode 21 and the second conductive structure 22 constitute a second touch electrode 2. The first touch electrode 1 and the second touch electrode 2 constitute a mutual-capacitive touch structure.

It should be noted that, the patterning process in the embodiment of the present disclosure includes, for example, photoresist coating, exposure, development, etching, photoresist stripping, etc.

In the embodiment of the present disclosure, in order to avoid the influence of the subsequent process on the first electrode 11 and the second electrode 21, the first insulating layer 4 may also cover the first electrode 11 and the second electrode 21.

It should be noted that, in the embodiment of the present disclosure, the first insulating layer 4 may cover the opening 13 or 23 or may not cover the opening 13 or 23. That is, referring to FIGS. 1 and 2, when the first insulating layer 4 as formed covers the opening 13 or 23, the electrostatic discharge structure 3 is located on the first insulating layer 4; when the first insulating layer 4 as formed does not cover the opening 13 or 23, the electrostatic discharge structure 4 is directly formed on the substrate 10 and surrounded by the first electrode 11 and the second electrode 21, as shown in FIG. 1.

In an exemplary embodiment of the present disclosure, the material of the first conductive layer includes indium tin oxide.

In an exemplary embodiment of the present disclosure, the material of the second conductive layer includes a metal material.

The detailed description of the electrostatic discharge structure in the embodiment of the present disclosure may refer to the corresponding description in the foregoing embodiment, and details are not described herein again.

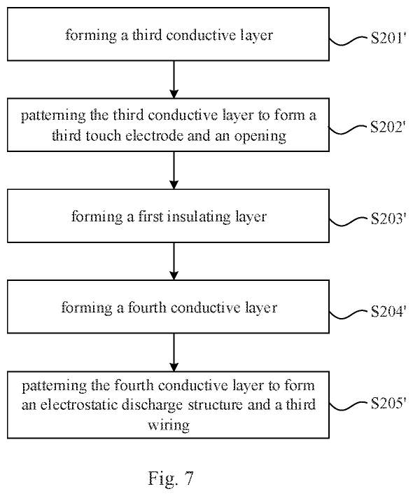

FIG. 7 is a flowchart of a method for manufacturing a touch substrate according to an embodiment of the present disclosure. The touch substrate manufactured by the method is shown in FIGS. 4 and 5. In the method, forming the touch electrode and the electrostatic discharge structure includes the following steps.

In step S201′, a third conductive layer is formed on the substrate 10′.

In step S202′, the third conductive layer is patterned to form a third touch electrode 5 and an opening 51 located in the third touch electrode, the third touch electrode 5 constituting a self-capacitive touch structure.

In step S203′, a first insulating layer 7 is formed on the third touch electrode 5, the first insulating layer 7 having a first hole 71 exposing the third touch electrode 5.

In step S204′, a fourth conductive layer is formed to cover the first insulating layer 7.

In step S205′, the fourth conductive layer is patterned to form an electrostatic discharge structure 3 and a third wiring 6 connected to the third touch electrode 5 through a first hole 71, the electrostatic discharge structure 3 being connected to the third touch electrode 5.

It should be noted that, in the embodiment of the present disclosure, the first insulating layer 7 may either cover the opening 51 or may not cover the opening 51.

That is, when the first insulating layer 7 as formed covers the opening 51, the electrostatic discharge structure 3 as formed is located on the first insulating layer 7; when the first insulating layer 7 as formed does not cover the opening 51, the electrostatic discharge structure 3 is directly formed on the substrate 10′ and surrounded by the third touch electrode 5.

In an exemplary embodiment of the present disclosure, the material of the third conductive layer includes indium tin oxide.

In an exemplary embodiment of the present disclosure, the material of the fourth conductive layer includes a metal material.

The detailed description of the electrostatic discharge structure in this embodiment may refer to the corresponding description in the foregoing embodiment, and details are not described herein again.

It is to be understood that the above embodiments are merely exemplary embodiments employed to explain the principles of the present disclosure, but the present disclosure is not limited thereto. Various modifications and improvements can be made by those skilled in the art without departing from the spirit and scope of the disclosure, and such modifications and improvements are also considered to be within the scope of the disclosure.

1. A touch substrate comprising:
a substrate; and
a touch electrode; and
an electrostatic discharge structure connected to the touch electrode on the substrate,
wherein the electrostatic discharge structure is configured to discharge static electricity generated in the touch electrode.

2. The touch substrate according to claim 1, wherein the touch electrode has an opening, and wherein an orthographic projection of the electrostatic discharge structure on the substrate is located within the opening.

3. The touch substrate according to claim 2, wherein the electrostatic discharge structure comprises a conductive grid structure.

4. The touch substrate according to claim 3, wherein the conductive grid structure comprises a first wiring and a second wiring intersecting with each other.

5. The touch substrate according to claim 4, wherein an end of the first wiring and an end of the corresponding second wiring are joined at an edge region of the electrostatic discharge structure to form a discharge tip.

6. The touch substrate according to claim 5, wherein a width of a portion, intersecting with the second wiring, of the first wiring is smaller than a width of a portion, not intersecting with the second wiring, of the first wiring, and
wherein a width of a portion, intersecting with the first wiring, of the second wiring is smaller than a width of a portion, not intersecting with the first wiring, of the second wiring.

7. The touch substrate according to claim 2, wherein the touch electrode comprises a first touch electrode disposed along a first direction and a second touch structure disposed along a second direction constituting a mutual-capacitive touch structure,
wherein the first touch electrode comprises a first electrode and a first conductive structure connecting the adjacent first electrodes,
wherein the second touch electrode comprises a second electrode and a second conductive structure connecting the adjacent second electrodes,
wherein the first conductive structure and the second conductive structure intersect with each other and are insulated from each other,
wherein at least one of the first electrode and the second electrode have the opening, and
wherein the electrostatic discharge structure is connected to a corresponding electrode of the first electrode and the second electrode, the corresponding electrode having the opening covered by the orthographic projection of the electrostatic discharge structure.

8. The touch substrate according to claim 7, wherein the electrostatic discharge structure is disposed in the same layer as the second conductive structure.

9. The touch substrate according to claim 2, wherein the touch electrode comprises a third touch electrode constituting a self-capacitive touch structure,
wherein the third touch electrode has the opening, and
wherein the electrostatic discharge structure is connected to the third touch electrode.

10. The touch substrate according to claim 9, wherein the touch electrode further comprises:
a first insulating layer located on the third touch electrode; and
a third wiring located on the first insulating layer, wherein the third wiring is connected to the third touch electrode through a first hole in the first insulating layer.

11. The touch substrate according to claim 4, wherein a material of the first wiring and the second wiring comprises a metal material.

12. A method for manufacturing a touch substrate, the method comprising:
providing a substrate; and
forming a touch electrode and an electrostatic discharge structure connected to the touch electrode on the substrate,
wherein the electrostatic discharge structure is configured to discharge static electricity generated in the touch electrode.

13. The method according to claim 12, wherein the touch electrode has an opening, and
wherein an orthographic projection of the electrostatic discharge structure on the substrate is located within the opening.

14. The method according to claim 13, wherein the electrostatic discharge structure comprises a conductive grid structure.

15. The method according to claim 14, wherein the conductive grid structure comprises a first wiring and a second wiring intersecting with each other.

16. The method according to claim 15, wherein an end of the first wiring and an end of the corresponding second wiring are joined at an edge region of the electrostatic discharge structure to form a discharge tip.

17. The method according to claim 16, wherein a width of a portion, intersecting with the second wiring, of the first wiring is smaller than a width of a portion, not intersecting with the second wiring, of the first wiring, and
wherein a width of a portion, intersecting with the first wiring, of the second wiring is smaller than a width of a portion, not intersecting with the first wiring, of the second wiring.

18. The method according to claim 13, wherein forming the touch electrode and the electrostatic discharge structure comprises:
forming a first conductive layer on the substrate;
patterning the first conductive layer to form a first electrode and a first conductive structure disposed along a first direction, a second electrode disposed along a second direction, and the opening in at least one of the first electrode and the second electrode, the first conductive structure connecting the adjacent first electrodes;
forming a first insulating layer on the first conductive structure;
forming a second conductive layer to cover the first electrode, the second electrode, the opening, and the first insulating layer; and
patterning the second conductive layer to form a second conductive structure and the electrostatic discharge structure disposed along the second direction, the second conductive structure intersecting with the first conductive structure and connecting the adjacent second electrodes, the electrostatic discharge structure connected to a corresponding electrode of the first electrode and the second electrode, the corresponding electrode having the opening covered by the orthographic projection of the electrostatic discharge structure,
wherein the first electrode and the first conductive structure constitute a first touch electrode, wherein the second electrode and the second conductive structure constitute a second touch electrode, and wherein the first touch electrode and the second touch electrode constitute a mutual-capacitive touch structure.

19. The method according to claim 13, wherein forming the touch electrode and the electrostatic discharge structure comprises:
forming a third conductive layer on the substrate;
patterning the third conductive layer to form a third touch electrode and the opening in the third touch electrode, the third touch electrode constituting a self-capacitive touch structure;
forming a first insulating layer on the third touch electrode, the first insulating layer having a first hole exposing the third touch electrode;
forming a fourth conductive layer to cover the first insulating layer; and
patterning the fourth conductive layer to form the electrostatic discharge structure and a third wiring connected to the third touch electrode through the first hole, the electrostatic discharge structure connected to the third touch electrode.

20. The method according to claim 19, wherein the first insulating layer further comprises a second hole exposing the opening, and
wherein the electrostatic discharge structure is located within the opening.
